(19) United States
(12) Patent Application Publication
(10) Pub. No.: US 2026/0171533 A1
(43) Pub. Date: Jun. 18, 2026

(54) THERMAL ENERGY CONTROL METHOD FOR VEHICLE

(71) Applicants: HYUNDAI MOTOR COMPANY, Seoul (KR); Kia Corporation, Seoul (KR)

(72) Inventors: Yeon Ho KIM, Hwaseong-si (KR); Yeongjae Park, Hwaseong-si (KR); Jong II Park, Hwaseong-si (KR)

(21) Appl. No.: 19/306,558

(22) Filed: Aug. 21, 2025

(30) Foreign Application Priority Data
Dec. 13, 2024 (KR) 10-2024-0185638

(51) Int. Cl. H01M 10/633; B60H 1/00; B60W 20/00; H01M 10/44; H01M 10/48; H01M 10/615; H01M 10/625; H01M 10/635; H01M 10/657; H01M 10/663

(52) U.S. Cl. CPC H01M 10/633; B60H 1/00278; B60H 1/00735; B60W 20/00; H01M 10/44; H01M 10/486; H01M 10/615; H01M 10/625; H01M 10/635; H01M 10/657; H01M 10/663; B60W 2510/244; B60W 2510/246; B60W 2555/20; B60W 2710/246; H01M 2220/20

(57) ABSTRACT

In an embodiment a method includes determining, by a controller, whether a state-of-charge of a battery is greater than or equal to 30% based on data from a data detector, determining, by the controller, whether a battery temperature is higher than 10° C. based on data from the data detector and based on determining that the state-of-charge of the battery is greater than or equal to 30%, determining, by the controller, whether an ambient air temperature is higher than −20° C. based on data from the data detector, operating, by the controller, an electric heater based on determining that the ambient air temperature is lower than or equal to −20° C., determining, by the controller, whether the battery temperature is higher than a target temperature and a vehicle interior temperature is higher than a user-set temperature based on data from the data detector and terminating the active thermal management control based on determining that the battery temperature is higher than a target temperature and the vehicle interior temperature is higher than the user-set temperature.

### CROSS-REFERENCE TO RELATED APPLICATIONS

This application claims priority to and the benefit of Korean Patent Application No. 10-2024-0185638 filed with the Korean Intellectual Property Office on Dec. 13, 2024, the entire contents of which is incorporated herein by reference.

### TECHNICAL FIELD

The present disclosure relates to a thermal energy control method for a vehicle, and more particularly, the present disclosure relates to a thermal energy control method for an electrical vehicle such as an extended range electric vehicle (EREV) provided with an engine in order to charge a battery for supplying electrical power to a drive motor.

### BACKGROUND

In general, improving fuel efficiency of vehicles is a key technology that will determine the survival of the future automobile industry. Accordingly, major automobile manufacturers are putting all their efforts into researching for improving the fuel efficiency of their vehicles to meet the demands of the times, such as environmental and fuel efficiency regulations.

Recently, in accordance with a continuous increase in interest in energy efficiency and an environmental pollution problem, the development of an environment-friendly vehicle capable of substantially substituting for an internal combustion engine vehicle may be required, and the environment-friendly vehicle is classified into an electric vehicle driven using a fuel cell or electricity as a power source and a hybrid vehicle driven using an engine and a battery.

Here, an electric vehicle (hereinafter referred to as “EV”) includes at least one high-voltage battery configured to supply power and enable movement.

Such a battery discharges over time or when used, and requires occasional charging. Accordingly, a typical EV may charge the battery by physically connecting to an external power supply by using a charging cable.

Meanwhile, recently, extended range electric vehicles (EREVs) that use a motor for driving and an engine only for charging to extend the driving distance are on the rise.

The EREV is an electric vehicle that uses the power of an internal combustion engine to charge a high-voltage battery, but does not transmit the power of the engine to the wheels.

In such an EREV, the engine can charge the battery using a motor generator unit (MGU) operated by the power of the engine when the state of charge (SOC) of the battery is low.

In addition, such an EREV may include, not only a cooling apparatus for the engine and the electrical component for adjusting the temperature of the engine and the electrical component by circulating the coolant, but also a heat pump apparatus for adjusting the vehicle interior temperature by circulating the refrigerant.

The EREV configured as such may require development of a control method for controlling the battery temperature as well as adjusting the temperature of the vehicle interior by using the thermal energy generated from the engine, the respective cooling apparatuses, and the heat pump apparatus.

The above information disclosed in this Background section is only for enhancement of understanding of the background of the disclosure, and therefore it may contain information that does not form the prior art that is already known in this country to a person of ordinary skill in the art.

### SUMMARY

Embodiments provide a thermal energy control method for a vehicle capable of selectively performing the heating of the vehicle interior while efficiently controlling the battery temperature by using the thermal energy generated from the engine, the electrical component, and the heat pump apparatus, in an extended range electric vehicle (EREV) applied with an engine for charging a battery configured to supply electrical power to a drive motor.

A thermal energy control method for a vehicle may include determining, by a controller, whether a state-of-charge of a battery is greater than or equal to 30% based on data detected from a data detector, during driving of the vehicle, determining, by the controller, whether a battery temperature is higher than 10° C. based on data detected from the data detector, when it is determined that the state-of-charge of the battery is greater than or equal to 30% (i.e., when the condition is satisfied) in the determining of whether the state-of-charge of the battery is greater than or equal to 30%, determining, by the controller, whether an ambient air temperature is higher than −20° C. based on data detected from the data detector, operating, by the controller, an electric heater, when it is determined that the ambient air temperature is lower than or equal to −20° C. (i.e., when the condition is not satisfied) in the determining of whether the ambient air temperature is higher than −20° C., determining, by the controller, whether the battery temperature is higher than a target temperature, and a vehicle interior temperature is higher than a user-set temperature, based on data detected from the data detector, and terminating the control, when it is determined that the battery temperature is higher than a target cell temperature, and the vehicle interior temperature is higher than the user-set temperature (i.e., when the condition is satisfied).

In the determining of whether the state-of-charge of the battery is greater than or equal to 30%, when it is determined that the state-of-charge of the battery is smaller than to 30% (i.e., when the condition is not satisfied), the controller may perform operating an engine in order to charge the battery.

The thermal energy control method may further include, determining, by the controller, whether a charge conditioning mode of the battery is operating, when it is determined that the battery temperature is higher than 10° C. (i.e., when the condition is satisfied) in the determining of whether the battery temperature is higher than 10° C., determining, by the controller, whether heating of the vehicle interior is turned off, when it is determined that the charge conditioning mode of the battery is operated (i.e., when the condition is satisfied) in the determining of whether the charge conditioning mode of the battery is operating, and determining, by the controller, whether an engine is turned OFF, when it is determined that the heating of the vehicle interior is turned OFF (i.e., when the condition is satisfied) in the determining of whether the heating of the vehicle interior is turned OFF.

When it is determined that the engine is in an OFF state (i.e., when the condition is satisfied) in the determining of whether the engine is turned OFF, the determining whether the ambient air temperature is higher than −20° C. may be performed.

The thermal energy control method may further include setting, by the controller, the battery as a normal conditioning mode, when it is determined that the battery temperature is lower than 10° C. (i.e., when the condition is not satisfied) in the determining of whether the battery temperature is higher than 10° C., and setting, by the controller, the battery as the charge conditioning mode, when it is determined that the charge conditioning mode of the battery is not operated (i.e., when the condition is not satisfied) in the determining of whether the charge conditioning mode of the battery is operating.

In the normal conditioning mode, the target cell temperature of the battery may be set to 10° C., and in the charge conditioning mode, the target cell temperature of the battery may be set to 20° C.

When the setting the battery to a normal conditioning mode is completed, the determining whether the charge conditioning mode of the battery is operating may be performed, and when the setting the battery to a charge conditioning mode is completed, the determining whether the heating of the vehicle interior is turned OFF may be performed.

The thermal energy control method may further include, setting a target temperature, by the controller, of the vehicle interior of a vehicle interior air-conditioner apparatus, when it is determined that the heating of the vehicle interior is not turned OFF (i.e., the heating of the vehicle interior is turned ON) (i.e., when the condition is not satisfied) in the determining whether the heating of the vehicle interior is turned OFF, and performing, by the controller, one of heating of the vehicle interior or heating of the battery by using the thermal energy generated from the engine, when it is determined that the engine is operated (i.e., when the condition is not satisfied) in the determining whether the engine is in an OFF state.

The target temperature of the vehicle interior may be set to the user-set temperature set by a user.

When the step of setting the target temperature of the vehicle interior of the vehicle interior air-conditioner apparatus is completed, the determining whether the engine is in an OFF state may be performed, and when the performing one of heating of the vehicle interior or heating of the battery by using the thermal energy generated from the engine, or the operating the electric heater is completed, the determining whether the battery temperature is higher than the target cell temperature, and the vehicle interior temperature is higher than the user-set temperature may be performed.

In the performing one of heating of the vehicle interior or heating of the battery by using the thermal energy generated from the engine, the heating of the vehicle interior may be performed when heating of the vehicle interior is turned ON.

The thermal energy control method may further include operating, by the controller, a heat pump apparatus, when it is determined that the ambient air temperature is higher than −20° C. (i.e., when the condition is satisfied) in the determining of whether the ambient air temperature is higher than −20° C., determining, by the controller, whether an increasing speed of a temperature of a coolant is higher than a predetermined value, based on data detected from the data detector, and determining, by the controller, whether a compressor discharge pressure P_{d} is higher than 15 bar, or whether a difference value between a refrigerant discharge temperature T_{d} and a coolant temperature T_{water} is higher than 20° C., when it is determined that the increasing speed of the temperature of the coolant is higher than the predetermined value (i.e., when the condition is satisfied) in the determining of whether a temperature of the coolant increase speed is higher than the predetermined value.

When it is determined that the increasing speed of the temperature of the coolant is lower than the predetermined value (i.e., when the condition is not satisfied) in the determining of whether the increasing speed of the temperature of the coolant is higher than the predetermined value, the method may return to the operating, by the controller, the electric heater.

In the determining whether the compressor discharge pressure P_{d} is higher than 15 bar, or whether the difference value between the refrigerant discharge temperature T_{d} and the coolant temperature T_{water} is greater than 20° C., when it is determined that the compressor discharge pressure P_{d} is higher than 15 bar, or that the difference value between the refrigerant discharge temperature T_{d} and the coolant temperature T_{water} is higher than 20° C. (i.e., when the condition is satisfied), the controller may perform turning OFF an operation of the heat pump apparatus.

In the determining whether the compressor discharge pressure P_{d} is higher than 15 bar, or whether the difference value between the refrigerant discharge temperature T_{d} and the coolant temperature T_{water} is greater than 20° C., when it is determined that the compressor discharge pressure P_{d} is lower than 15 bar, or that the difference value between the refrigerant discharge temperature T_{d} and the coolant temperature T_{water} is lower than 20° C. (i.e., when the condition is not satisfied), the determining whether the battery temperature is higher than the target cell temperature, and the vehicle interior temperature is higher than the user-set temperature may be performed.

In the determining whether the battery temperature is higher than a predetermined target cell temperature, and the vehicle interior temperature is higher than the user-set temperature, when it is determined that the battery temperature is lower than the target cell temperature, and the vehicle interior temperature is lower than the user-set temperature (i.e., when the condition is not satisfied), the control method may return to the determining whether the battery temperature is higher than 10° C.

The data detector may include a battery state-of-charge sensor configured to measure the state-of-charge of the battery, a battery temperature sensor configured to measure the battery temperature, an external temperature sensor configured to measure an external temperature, a vehicle interior temperature sensor configured to measure the vehicle interior temperature, a coolant temperature sensor configured to measure a temperature of a coolant, a refrigerant temperature sensor configured to measure a temperature of a refrigerant circulating in a heat pump apparatus, and a refrigerant pressure sensor configured to measure a pressure of the refrigerant discharged from a compressor included in the heat pump apparatus.

As described above, according to a thermal energy control method for a vehicle according to an embodiment, in an extended range electric vehicle (EREV) applied with an engine for charging a battery configured to supply electrical power to a drive motor, the heating of the vehicle interior may be selectively performed while efficiently controlling the battery temperature by using the thermal energy generated from the engine, the electrical component, and the heat pump apparatus.

In addition, according to the present disclosure, the thermal energy is efficiently utilized according to the coolant temperature, the refrigerant discharge pressure, the refrigerant discharge temperature, or the like so that the battery is controlled at a target cell temperature, and at the same time, heating of the vehicle interior is rapidly performed to the vehicle interior target temperature set by a user, thereby increasing the fast-acting properties of the temperature control of the battery and the vehicle interior heating, and improving the overall marketability of the vehicle.

In addition, according to the present disclosure, the battery may be used and charged at an optimal temperature state, thereby improving the charging speed and efficiency.

In addition, according to the present disclosure, by efficiently controlling the battery temperature, the optimal performance of the battery may be obtained, and the overall travel distance of the vehicle may be increased through efficient management of battery.

### BRIEF DESCRIPTION OF THE DRAWINGS

FIG. 1 is a block diagram showing a thermal energy control apparatus to which a thermal energy control method for a vehicle according to an embodiment is applied.

FIG. 2A and FIG. 2B are control flowcharts for explaining a thermal energy control method for a vehicle according to an embodiment.

### DETAILED DESCRIPTION OF ILLUSTRATIVE EMBODIMENTS

An embodiment will hereinafter be described in detail with reference to the accompanying drawings.

Exemplary embodiments disclosed in the present specification and the constructions depicted in the drawings are only the preferred embodiments of the present disclosure, and do not cover the entire scope of the present disclosure. Therefore, it will be understood that there may be various equivalents and variations at the time of the application of this specification.

In order to clarify the present disclosure, parts that are not related to the description will be omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc., are exaggerated for clarity.

In addition, unless explicitly described to the contrary, the word “comprise” and variations such as “comprises” or “comprising”, will be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation.

A thermal energy control method for a vehicle according to an embodiment may be applied to an extended range electric vehicle (EREV) which is driven by the power of a drive motor and to which an engine 20 is applied for charging a battery 10 configured to supply electrical power to the drive motor.

Such a thermal energy control method can efficiently control the temperature of the battery 10 depending on a state-of-charge of the battery 10, while performing heating of the vehicle interior, by using the thermal energy generated from the engine 20, the electrical component, and a heat pump apparatus 50.

Here, the battery 10, the engine 20, and the electrical component may be connected to a plurality of coolant lines through which a coolant flows, and a cooling apparatus including a valve, a radiator, and a water pump, or the like, connected to the coolant lines and configured to control a flowing movement of the coolant.

Accordingly, the cooling apparatus may adjust the temperature of the battery 10, the engine 20, and the electrical component by using the coolant, and may selectively recollect and use the thermal energy generated from the battery 10, the engine 20, and the electrical component.

Such a cooling apparatus may be linked with the heat pump apparatus 50 in which a refrigerant circulates.

The heat pump apparatus 50 may basically include a compressor, a condenser, an expansion valve, and an evaporator, connected through the refrigerant line. In addition, the heat pump apparatus 50 may further include a chiller configured to heat-exchange the coolant and the refrigerant.

The heat pump apparatus 50 may, while heat-exchanging the coolant supplied from the cooling apparatus with the refrigerant, selectively recollect the thermal energy from the coolant, to change the phase of the refrigerant.

As such, the EREV including the battery 10, the engine 20, the electrical component, the cooling apparatus, and the heat pump apparatus 50 may further include a vehicle interior air-conditioner apparatus 30 for adjusting a temperature of a vehicle interior, and an electric heater 40 used for heating the vehicle interior when the thermal energy is not insufficient.

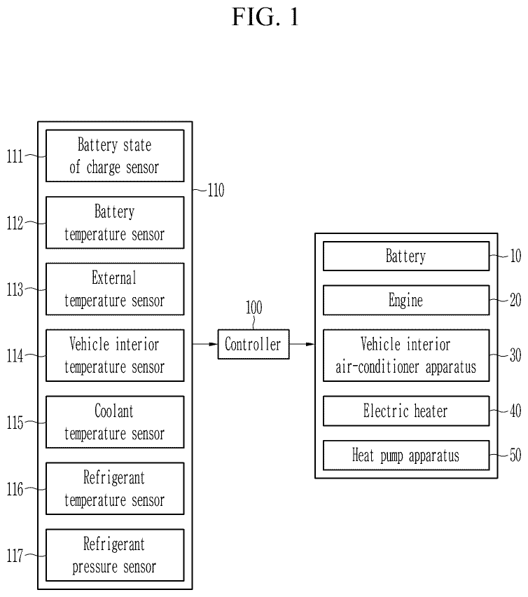

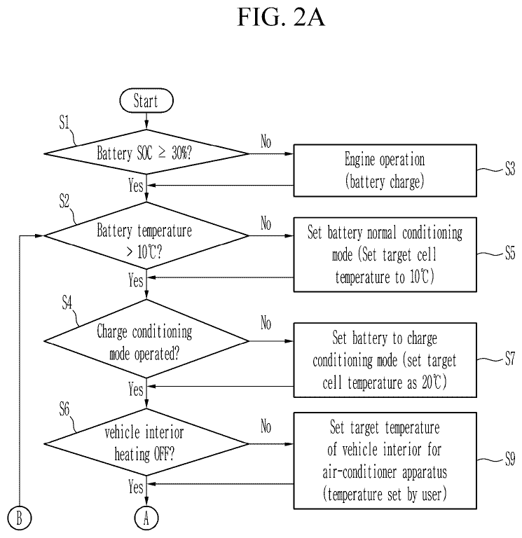

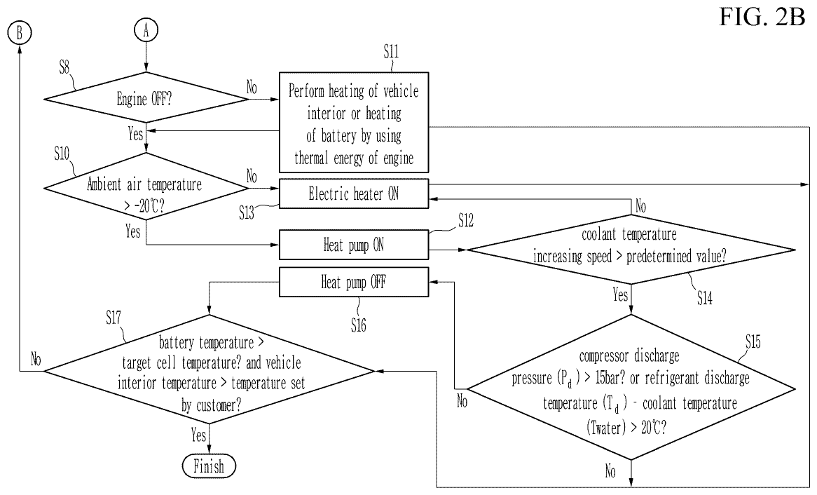

FIG. 1 is a block diagram showing a thermal energy control apparatus to which a thermal energy control method for a vehicle according to an embodiment is applied, and FIG. 2A and FIG. 2B are control flowcharts for explaining a thermal energy control method for a vehicle according to an embodiment.

In EREV configured as described above, as shown in FIG. 1, the battery 10, the engine 20, the vehicle interior air-conditioner apparatus 30, the electric heater 40, and the heat pump apparatus 50 may be controlled by the thermal energy control apparatus, and the thermal energy control apparatus may include a controller 100 and data detector 110.

In the present embodiment, the data detector 110 may detect data for the controller 100 to control the operation of the battery 10, the engine 20, the vehicle interior air-conditioner apparatus 30, the electric heater 40, and the heat pump apparatus 50.

The data detected from the data detector 110 may be transferred to the controller 100. The data detector 110 may include a battery state-of-charge sensor 111, a battery temperature sensor 112, an external temperature sensor 113, the vehicle interior temperature sensor 114, a coolant temperature sensor 115, a refrigerant temperature sensor 116, and a refrigerant pressure sensor 117.

First, the battery state-of-charge sensor 111 may measure the state-of-charge of the battery 10. The battery state-of-charge sensor 111 may measure the state-of-charge of the battery 10, and may transfer a signal related thereto to the controller 100.

The battery temperature sensor 112 may measure the temperature of the battery 10. The battery state-of-charge sensor 111 may measure the temperature of the battery 10, and may transfer a signal related thereto to the controller 100.

The external temperature sensor 113 may measure the vehicle external temperature. The external temperature sensor 113 may measure the vehicle external temperature, and may transfer a signal related thereto to the controller 100.

The vehicle interior temperature sensor 114 may measure the vehicle interior temperature. The vehicle interior temperature sensor 114 may measure the vehicle interior temperature, and may transfer a signal related thereto to the controller 100.

The coolant temperature sensor 115 may measure a temperature of the coolant circulating from the cooling apparatus. The coolant temperature sensor 115 may measure a coolant temperature T_{water}, and may transfer a signal related thereto to the controller 100.

The refrigerant temperature sensor 116 may measure the temperature of the refrigerant discharged from the compressor of the heat pump apparatus 50. The refrigerant temperature sensor 116 may measure a refrigerant discharge temperature T_{d} discharged from compressor, and may transfer a signal related thereto to the controller 100.

In addition, the refrigerant pressure sensor 117 may measure the pressure of the refrigerant discharged from the compressor. The refrigerant pressure sensor 117 may measure a compressor discharge pressure P_{d}, and may transfer a signal related thereto to the controller 100.

An electrical component temperature sensor 114 may measure the temperature of the electrical component 4 while the vehicle is being driven. The electrical component temperature sensor 114 may measure the temperature of the electrical component 4, and may transfer a signal related thereto to the controller 100.

Here, the controller 100 may be implemented as one or more processors operable by a predetermined program, and the predetermined program may include a set of instructions for performing each step included in a control method of a cooling system according to an embodiment described later.

Accordingly, a thermal energy control method for a vehicle according to an embodiment may selectively perform the heating of the vehicle interior, while efficiently controlling the temperature of the battery 10, by using the thermal energy generated from an engine 10, an electrical component, and the heat pump apparatus 50, based on the data detected by the data detector 110.

For such a purpose, as shown in FIG. 2A and FIG. 2B, in a thermal energy control method for a vehicle according to an embodiment, during driving of the vehicle, the controller 100 may determine whether the state-of-charge of the battery 10 is greater than or equal to 30% based on data detected from the data detector 110, at step S1.

When it is determined that the state-of-charge of the battery 10 is greater than or equal to 30% (i.e., when the condition is satisfied) at the step S1 of determining whether the state-of-charge of the battery 10 is greater than or equal to 30%, the controller 100 may determine whether the temperature of the battery 10 is higher than 10° C. based on data detected from the data detector 110, at step S2.

To the contrary, when it is determined that the state-of-charge of the battery 10 is smaller than 30% (i.e., when the condition is not satisfied) in the determining of whether the state-of-charge of the battery 10 is greater than or equal to 30%, the controller 100 may operate the engine 20 in order to charge the battery 10, at step S3.

That is, in the EREV, the engine 20 may be operated by the controller 100, so as to charge the battery 10 when the state-of-charge of the battery 10 is lower than 30%. When the engine 20 is operated, the coolant may be supplied to the engine 20 along the coolant lines, in order to adjust the temperature of the engine 20.

When the step S3 of operating the engine 20 is completed, the controller 100 may perform the step S3 of determining whether the temperature of the battery 10 is higher than 10° C.

When it is determined that the temperature of the battery 10 is higher than 10° C. (i.e., when the condition is satisfied) at the step S3 of determining whether the temperature of the battery 10 is higher than 10° C., the controller 100 may determine whether a charge conditioning mode of the battery 10 is operating, at step S4.

On the other hand, when it is determined that the temperature of the battery 10 is lower than or equal to 10° C. (i.e., when the condition is not satisfied) at the step S3 of determining whether the temperature of the battery 10 is higher than 10° C., the controller 100 may set the battery 10 to be in a normal conditioning mode, at step S5.

Here, the battery conditioning refers to the battery temperature management for energy efficiency, and in the normal conditioning mode, a target cell temperature of the battery 10 may be set to 10° C.

When the step S5 of setting the battery 10 to be in the normal conditioning mode is completed, the step S4 of determining whether the charge conditioning mode of the battery 10 is operated may be performed.

When it is determined that the charge conditioning mode of the battery 10 is operated (i.e., when the condition is satisfied) at the step S4 of determining whether the charge conditioning mode of the battery 10 is operated, the controller 100 may determine whether the heating of the vehicle interior is turned OFF, at step S6.

To the contrary, when it is determined that the charge conditioning mode of the battery 10 is not operated (i.e., when the condition is not satisfied) at the step S4 of determining whether the charge conditioning mode of the battery 10 is operated, the controller 100 may set the battery 10 to be in the charge conditioning mode, at step S7.

Here, in the charge conditioning mode, the target cell temperature of the battery 10 may be set to 20° C.

When the step S7 of setting the battery 10 to be in the charge conditioning mode is completed, the controller 100 may perform the step S6 of determining whether the heating of the vehicle interior is turned OFF, again.

At the step S6 of determining whether the heating of the vehicle interior is turned OFF, when it is determined that the heating of the vehicle interior is turned OFF (i.e., when the condition is satisfied), the controller 100 may determine whether the engine 10 is turned OFF, at step S8.

To the contrary, when it is determined that the heating of the vehicle interior is not turned OFF (i.e., the heating of the vehicle interior is turned ON) (i.e., when the condition is not satisfied) at the step S6 of determining whether the heating of the vehicle interior is turned OFF, the controller 100 may set a target temperature of the vehicle interior of the vehicle interior air-conditioner apparatus 30, at step S9.

Here, the target temperature of the vehicle interior may be set to a user-set temperature that is set by a user.

When the step S9 of setting the target temperature of the vehicle interior of the vehicle interior air-conditioner apparatus 30 is completed, the controller 100 may perform the step S8 of determining whether the engine 20 is in an OFF state, again.

When it is determined that the engine 20 is in an OFF state (i.e., when the condition is satisfied) at the step S8 of determining whether the engine 20 is turned OFF, the controller 100 may determine whether an ambient air temperature is higher than −20° C. based on data detected from the data detector 110, at step S10.

On the other hand, when it is determined that the engine 20 is operated (i.e., when the condition is not satisfied) at the step S8 of determining whether the engine 20 is in an OFF state, the controller 100 may perform one of heating of the vehicle interior or heating of the battery 10, by using the thermal energy generated from the engine 10, at step S11.

Here, heating of the vehicle interior may be performed when heating of the vehicle interior is turned ON.

In more detail, the controller 100 may control the cooling apparatus so that the coolant heated while cooling the engine 20 is supplied to the battery 10.

Accordingly, the coolant heated by the thermal energy of the engine 20 may rapidly increase the temperature of the battery 10.

In addition, when heating of the vehicle interior is turned ON, the controller 100 may also perform the heating of the vehicle interior, by supplying the coolant with the increased temperature to a heater core provided in a HVAC module.

Meanwhile, when it is determined that the ambient air temperature is higher than −20° C. (i.e., when the condition is satisfied) at the step S10 of determining whether the ambient air temperature is higher than −20° C., the controller 100 may operate the heat pump apparatus 50, at step S12.

When the heat pump apparatus 50 is operated, in the heat pump apparatus 50, the refrigerant may be circulated by an operation of respective components. At this time, the heat pump apparatus 50 may heat-exchange the coolant circulating through the battery 10 with the refrigerant.

Accordingly, the heat pump apparatus 50 may increase the temperature of the coolant circulating through the battery 10 by using the thermal energy generated while the refrigerant changes its phase. The coolant heated by the thermal energy of the heat pump apparatus 50 may increase the temperature of the battery 10.

On the other hand, when it is determined that the ambient air temperature is lower than −20° C. (i.e., when the condition is not satisfied) at the step S10 of determining whether the ambient air temperature is higher than −20° C., the controller 100 may operate the electric heater 40, at step S13.

That is, when the ambient air temperature is lower than −20° C., the controller 100 may not operate the heat pump apparatus 50 but may operate only the electric heater 40, in order to protect the heat pump apparatus 50.

Accordingly, the electric heater 40 may heat the coolant supplied to the battery 10, to increase the temperature of the coolant. The coolant heated in the electric heater 40 may be supplied to the battery 10, thereby increasing the temperature of the battery 10.

In the present embodiment, when the step S12 of operating the heat pump apparatus 50 is completed, the controller 100 may determine whether the increasing speed of the temperature of the coolant supplied to the battery 10 is higher than a predetermined value, based on data detected from the data detector 110, at step S14.

At the step S14 of determining whether the increasing speed of the temperature of the coolant is higher than the predetermined value, when it is determined that the increasing speed of the temperature of the coolant is lower than the predetermined value (i.e., when the condition is not satisfied), the controller 100 may return to the step S13 of operating the electric heater 40.

That is, while the heat pump apparatus 50 is being operated, when the increasing speed of the temperature of the coolant heated through heat-exchange with the refrigerant is determined to be lower than the predetermined value, the fast-acting properties of increasing the coolant temperature may be deteriorated.

Accordingly, in order to rapidly increase the temperature of the coolant, the controller 100 may operate the electric heater 40 together with the heat pump apparatus 50.

To the contrary, at the step S14 of determining whether the increasing speed of the temperature of the coolant is higher than the predetermined value, when it is determined that the increasing speed of the temperature of the coolant is higher than the predetermined value (i.e., when the condition is satisfied), the controller 100 may determine whether a compressor discharge pressure P_{d} is higher than 15 bar, or whether a difference value between the refrigerant discharge temperature T_{d} and the coolant temperature T_{water} is higher than 20° C., based on data detected from the data detector 110, at step S15.

At the step S15 of determining whether the compressor discharge pressure P_{d} is higher than 15 bar, or whether the difference value between the refrigerant discharge temperature T_{d} and the coolant temperature T_{water} is higher than 20° C., when it is determined that the compressor discharge pressure P_{d} is higher than 15 bar, or that the difference value between the refrigerant discharge temperature T_{d} and the coolant temperature T_{water} is higher than 20° C. (i.e., when the condition is satisfied), the controller 100 may turn OFF the operation of the heat pump apparatus 50, at step S16.

That is, in the heat pump apparatus, when the compressor discharge pressure is a high pressure or the refrigerant discharge temperature T_{d} is low compared to the coolant temperature T_{water}, the controller 100 may determine that the heat pump apparatus 50 is operating in a guard range or an inefficiency range and may turn OFF the operation of the heat pump apparatus 50.

When the step S16 of turning OFF the operation of the heat pump apparatus 50 is completed, the controller 100 may determine whether the temperature of the battery 10 is higher than the target temperature, and the vehicle interior temperature is higher than the user-set temperature, based on data detected from the data detector 110, at step S17.

At the step S17 of determining whether the temperature of the battery 10 is higher than the target temperature, and the vehicle interior temperature is higher than the user-set temperature, when it is that the temperature of the battery 10 is higher than the target cell temperature, and the vehicle interior temperature is higher than the user-set temperature (i.e., when the condition is satisfied), the active thermal management control may be terminated.

To the contrary, at the step S17 of determining whether the temperature of the battery 10 is higher than a predetermined target cell temperature, and the vehicle interior temperature is higher than the user-set temperature, when it is determined that the temperature of the battery 10 is lower than the target cell temperature, and the vehicle interior temperature is lower than the user-set temperature (i.e., when the condition is not satisfied), the process may return to the step S2 of determining whether the temperature of the battery 10 is higher than 10° C., and may repeatedly perform the above-described processes.

Meanwhile, in the present embodiment, when the step S11 of performing one of heating of the vehicle interior or heating of the battery by using the thermal energy generated from the engine 20 or the step S13 of operating the electric heater 40 is completed, the step S17 of determining whether the battery temperature is higher than the target cell temperature, and the vehicle interior temperature is higher than the user-set temperature may be performed.

In addition, in the present embodiment, at the step S15 of determining whether the compressor discharge pressure P_{d} is higher than 15 bar, or whether the difference value between the refrigerant discharge temperature T_{d} and the coolant temperature T_{water} is higher than 20° C., when it is determined that the compressor discharge pressure P_{d} is lower than 15 bar, or that the difference value between the refrigerant discharge temperature T_{d} and the coolant temperature T_{water} is lower than 20° C. (i.e., when the condition is not satisfied), the controller 100 may perform the step S17 of determining whether the temperature of the battery 10 is higher than the target cell temperature, and the vehicle interior temperature is higher than the user-set temperature.

Therefore, as described above, according to a thermal energy control method for a vehicle according to an embodiment, in an extended range electric vehicle (EREV) applied with the engine 20 for charging of the battery 10 configured to supply electrical power to a drive motor, by using the thermal energy generated from the engine 20, the electrical component, and the heat pump apparatus 50, the heating of the vehicle interior may be selectively performed, while efficiently controlling the temperature of the battery 10.

In addition, according to the present disclosure, the thermal energy is efficiently utilized according to the coolant temperature, the refrigerant discharge pressure, the refrigerant discharge temperature, or the like so that the battery is controlled at a target cell temperature, and at the same time, heating of the vehicle interior is rapidly performed to the vehicle interior target temperature set by a user, thereby increasing the fast-acting properties of the temperature control of the battery 10 and the vehicle interior heating, and improving the overall marketability of the vehicle.

In addition, according to the present disclosure, the battery 10 may be used and charged at an optimal temperature state, thereby improving the charging speed and efficiency.

In addition, according to the present disclosure, by efficiently controlling the temperature of the battery 10, the optimal performance of the battery 10 may be obtained, and the overall travel distance of the vehicle may be increased through the efficient management of the battery 10.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of appended claims.

What is claimed is:

1. A thermal energy control method comprising:
determining, by a controller, whether a state-of-charge of a battery is greater than or equal to 30% based on data from a data detector;
determining, by the controller, whether a battery temperature is higher than 10° C. based on data received from the data detector and based on determining that the state-of-charge of the battery is greater than or equal to 30%;
determining, by the controller, whether an ambient air temperature is higher than −20° C. based on data received from the data detector;
operating, by the controller, an electric heater based on determining that the ambient air temperature is lower than or equal to −20° C.;
determining, by the controller, whether the battery temperature is higher than a target temperature and a vehicle interior temperature is higher than a user-set temperature based on data received from the data detector; and
terminating the active thermal management control based on determining that the battery temperature is higher than the target temperature and the vehicle interior temperature is higher than the user-set temperature.

2. The thermal energy control method of claim 1, wherein, in response to determining that the state-of-charge of the battery is smaller than 30%, performing, by the controller, operating an engine for charging the battery.

3. The thermal energy control method of claim 1, further comprising:
determining, by the controller, whether a charge conditioning mode of the battery is operating, based on determining that the battery temperature is higher than 10°C ;
determining, by the controller, whether heating of the vehicle interior is turned off based on determining that the charge conditioning mode of the battery is operating ; and
determining, by the controller, whether an engine is turned off based on determining that the heating of the vehicle interior is turned off.

4. The thermal energy control method of claim 3, wherein, in response to determining that the engine is in an OFF state determining, by the controller, whether the ambient air temperature is higher than −20° C..

5. The thermal energy control method of claim 3, further comprising:
setting, by the controller, the battery as being in a normal conditioning mode based on determining that the battery temperature is equal to or lower than 10° C.; and
setting, by the controller, the battery as being in the charge conditioning mode based on determining that the charge conditioning mode of the battery is not operating.

6. The thermal energy control method of claim 5,
wherein, in the normal conditioning mode, the target temperature of the battery is set to 10° C., and
wherein, in the charge conditioning mode, the target temperature of the battery is set to 20° C.

7. The thermal energy control method of claim 5, further comprising:
after setting the battery to the normal conditioning mode, determining whether the charge conditioning mode of the battery is operating; and
after setting the battery to the charge conditioning mode, determining whether the heating of the vehicle interior is turned off.

8. The thermal energy control method of claim 3, further comprising:
setting, by the controller, a target temperature of the vehicle interior by a vehicle interior air-conditioner based on determining that the heating of the vehicle interior is turned on ; and
performing, by the controller, one of heating of the vehicle interior or heating of the battery by using thermal energy generated by the engine based on determining that the engine is operating.

9. The thermal energy control method of claim 8, wherein the target temperature of the vehicle interior is set by a user.

10. The thermal energy control method of claim 8, further comprising:
after setting the target temperature of the vehicle interior, determining whether the engine is in an off state; and
after performing one of heating of the vehicle interior or heating of the battery, or operating the electric heater, determining whether the battery temperature is higher than the target temperature and the vehicle interior temperature is higher than the set temperature.

11. The thermal energy control method of claim 8, wherein performing one of heating of the vehicle interior or heating of the battery, performing the heating of the vehicle interior based on determining that heating of the vehicle interior is turned on.

12. The thermal energy control method of claim 1, further comprising:
operating, by the controller, a heat pump apparatus based on determining that the ambient air temperature is higher than −20° C.;
determining, by the controller, whether a speed of a temperature of a coolant is higher than a predetermined value based on data from the data detector;
and determining, by the controller, whether a compressor discharge pressure P_{d} is higher than 15 bar, or whether a difference value between a refrigerant discharge temperature T_{d} and a coolant temperature T_{water} is higher than 20° C. based on determining that the speed of the temperature of the coolant is higher than the predetermined value.

13. The thermal energy control method of claim 12, further comprising, in response to determining that the speed of the temperature of the coolant is lower than the predetermined value, operating, by the controller, the electric heater.

14. The thermal energy control method of claim 12, wherein, in response to determining that the compressor discharge pressure P_{d} is higher than 15 bar, or whether the difference value between the refrigerant discharge temperature T_{d} and the coolant temperature T_{water} is greater than 20° C.,
turning off, by the controller an operation of the heat pump apparatus.

15. The thermal energy control method of claim 12, wherein, in response to determining the compressor discharge pressure P_{d} is higher than 15 bar, or whether the difference value between the refrigerant discharge temperature T_{d} and the coolant temperature T_{water} is greater than 20° C.,
determining that the battery temperature is higher than the target temperature and the vehicle interior temperature is higher than the user-set temperature.

16. The thermal energy control method of claim 5, further comprising, in response to determining that the battery temperature is not equal or higher than a predetermined target temperature and that the vehicle interior temperature is not equal or higher than the set temperature,
returning to determining whether the battery temperature is higher than 10° C.

17. The thermal energy control method of claim 1, wherein the data detector comprises:
a battery state-of-charge sensor configured to measure the state-of-charge of the battery;
a battery temperature sensor configured to measure the battery temperature;
an external temperature sensor configured to measure an external temperature;
a vehicle interior temperature sensor configured to measure the vehicle interior temperature;
a coolant temperature sensor configured to measure a temperature of a coolant;
a refrigerant temperature sensor configured to measure a temperature of a refrigerant circulating in a heat pump apparatus; and
a refrigerant pressure sensor configured to measure a pressure of the refrigerant discharged from a compressor comprised in the heat pump apparatus.

18. A thermal energy control system comprising:
a controller; and
a data detector;
an electrical heater,
wherein the controller is communicatively connected to the data detector and the electrical heater, and
wherein the controller is configured to:
determine whether a state-of-charge of a battery is greater than or equal to 30% based on data received from data detector;
determine whether a battery temperature is higher than 10° C. based on data received from the data detector and based on determining that the state-of-charge of the battery is greater than or equal to 30%;
determine whether an ambient air temperature is higher than −20° C. based on data received from the data detector;
operate the electric heater based on determining that the ambient air temperature is lower than or equal to −20° C.;
determine whether the battery temperature is higher than a target temperature and a vehicle interior temperature is higher than a user-set temperature based on data from the data detector; and
terminate the active thermal management based on determining that the battery temperature is higher than the target temperature and the vehicle interior temperature is higher than the user-set temperature.

19. The thermal energy control system of claim 18, wherein the data detector comprises:
a battery state-of-charge sensor configured to measure the state-of-charge of the battery;
a battery temperature sensor configured to measure the battery temperature;
an external temperature sensor configured to measure an external temperature;
a vehicle interior temperature sensor configured to measure the vehicle interior temperature;
a coolant temperature sensor configured to measure a temperature of a coolant;
a refrigerant temperature sensor configured to measure a temperature of a refrigerant circulating in a heat pump apparatus; and
a refrigerant pressure sensor configured to measure a pressure of the refrigerant discharged from a compressor comprised in the heat pump apparatus.

20. A thermal energy control method comprising:
determining, by a controller, whether a state-of-charge of a battery is greater than or equal to a preset state of charge based on data from a data detector;
determining, by the controller, whether a battery temperature is higher than a first battery temperature based on data received from the data detector and based on determining that the state-of-charge of the battery is greater than or equal to preset state of charge;
determining, by the controller, whether an ambient air temperature is higher than a negative temperature based on data received from the data detector;
determining, by the controller, whether the battery temperature is higher than a target temperature and a vehicle interior temperature is higher than a user-set temperature based on data received from the data detector; and
terminating the active thermal management control based on determining that the battery temperature is higher than the target temperature and the vehicle interior temperature is higher than the user-set temperature.
